(19) United States
(12) Patent Application Publication
(10) Pub. No.: US 2010/0208325 A1
(43) Pub. Date: Aug. 19, 2010

(54) ELECTROACTIVE MATERIAL CONTAINING ORGANIC COMPOUNDS HAVING POSITIVE AND NEGATIVE REDOX ACTIVITIES RESPECTIVELY, PROCESS AND KIT FOR MANUFACTURING THIS MATERIAL, ELECTRICALLY CONTROLLABLE DEVICE AND GLAZING UNITS USING SUCH AN ELECTROACTIVE MATERIAL

(75) Inventors: Fabienne Piroux, La Plaine Saint-Denis (FR); Pascal Petit, Gagny (FR); Annabelle Andreau-Wiedenmaier, Aachen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/666,672

(22) PCT Filed: Jun. 25, 2008
(86) PCT No.: PCT/FR2008/051160

§ 371 Date: Dec. 24, 2009

(30) Foreign Application Priority Data
Jun. 25, 2007 (FR) 0755986

(51) Int. Cl. G02F 1/15; B29D 11/00; H01B 1/12

(52) U.S. Cl. 359/268; 359/265; 359/275; 264/1.1; 252/500

(57) ABSTRACT

This electroactive material comprises a self-supporting polymer matrix, inserted into which is an electroactive system comprising or constituted by:
at least one electroactive organic compound capable of being reduced and/or of accepting electrons and cations acting as compensation charges;
at least one electroactive organic compound capable of being oxidized and/or of ejecting electrons and cations acting as compensation charges;
at least one of said aforementioned electroactive organic compounds being electrochromic in order to obtain a color contrast,
ionic charges;
   and also a solubilization liquid for said electroactive system, said liquid not dissolving said self-supporting polymer matrix, the latter being chosen to provide a percolation pathway for ionic charges, this allowing, under the action of a dielectric current, oxidation and reduction reactions of said electroactive organic compounds, which reactions are necessary to obtain a color contrast.

The present invention relates to an electroactive material for an electrically controllable device said to have variable optical and/or energy properties, said electroactive material containing organic compounds having positive and negative redox activity respectively, to a process and a kit for manufacturing this material, to an electrically controllable device, and to glazing units using such an electroactive material.

An electrically controllable device may be defined in a general manner as comprising the following stack of layers:
a first substrate having a glass function;
a first electronically conductive layer with an associated current feed;
an electroactive system;
a second electronically conductive layer with an associated current feed; and
a second substrate having a glass function.

Known layered electroactive systems comprise two layers of electroactive material separated by an electrolyte, the electroactive material of at least one of the two layers being electrochromic. In the case where both electroactive materials are electrochromic materials, these may be identical or different. In the case where one of the electroactive materials is electrochromic and the other is not, the latter will have the role of a counterelectrode that does not participate in the coloring and bleaching processes of the system. Under the action of an electric current, the ionic charges of the electrolyte are inserted into one of the layers of electrochromic material and are ejected from the other layer of electrochromic material or counterelectrode to obtain a color contrast.

International Application PCT WO 2005/008326 describes an active system obtained by the process consisting in:
taking a matrix made of a film of poly(ethylene oxide) generally known as POE;
swelling this matrix in the monomer 3,4-ethylene-dioxythiophene (EDOT);
polymerizing the EDOT to obtain a POE film on both faces of which is the electrochromic polymer poly(3,4-ethylenedioxythiophene) (PEDOT); and
swelling the thus treated film in a solvent (such as propylene carbonate) in which a salt (such as lithium perchlorate) is dissolved.

This active system has the advantage of having a certain mechanical strength, in other words of being self-supporting.

However, as may be observed, the manufacture of the active system is complex, therefore difficult to implement on an industrial scale. Furthermore, the contrast that may be obtained, namely the light transmission in the bleached state/light transmission in the colored state ratio in the case of two identical electrochromic materials is barely satisfactory, often quite close to 2, and the system is generally quite dark, even in the bleached state, with light transmissions often less than 40%, or even 25%.

Thus, the solution proposed by WO 2005/008326 does not make it possible to advantageously replace the current solution which is to use a gelled electrolyte (see, for example, EP 0 880 189 B1; U.S. Pat. No. 7,038,828 B2).

When a gelled electrolyte is used for the purpose of conferring a certain behavior on the electrolyte, introduced into a “reservoir” zone between the two layers of electrochromic material, for example of PEDOT polymer, polyaniline or polypyrrole, or between one layer of electrochromic material or one counter-electrode layer, each of the two layers in question being in contact with the layer of electronic conductor (such as a TCO (transparent conductive oxide)). The gelled electrolyte is composed of a polymer, prepolymer (PMMA, POE for example) or monomer as a blend with a solvent and a dissolved salt, and after introducing the electrically controllable device into the “reservoir” zone, it may, for example, be heated in order to give rise to a crosslinking of the polymer or prepolymer or a polymerization of the monomer.

Besides the fact that it is not easy industrially to introduce the gel or a solution which will then be gelled into the reservoir, the electrolyte materials described previously are not self-supporting. This solution cannot be successfully applied to devices which may be of a large size (such as glazing units) which are used in a vertical position and for which a displacement of the medium within the reservoir occurs under the effect of its own weight, which risks, if the two substrates are not sufficiently mechanically reinforced by a peripheral seal, resulting in an opening of the glazing unit due to the hydrostatic pressure which gives a “belly” to the glazing unit. Furthermore, these electrolytes in the form of gels contain large amounts of solvent(s), which are capable of interacting with the encapsulation material, which would risk causing or promoting a detachment of the two substrates of the glazing unit.

Such electroactive systems are not always satisfactory; in particular they require a relatively high voltage to obtain an acceptable color contrast for the commercial exploitation of the electrically controllable device.

Also known from U.S. Pat. No. 4,902,108 is an active medium formed by two electrochromic organic compounds respectively having cathodic coloration and anodic coloration dissolved in a solvent. The solution obtained is introduced into a sealed space between two sheets of glass that are coated on the inside with an electronically conductive layer. Such an “aquarium” assembly is difficult to implement, since it is necessary to manufacture the aquarium and fill it, the filling techniques being quite inconvenient since it is necessary to manage to expel all the air bubbles, often under vacuum, with processes that are very difficult or even impossible to implement for large-size glazing units. Studies have then been carried out to attempt to solidify this active medium. Thus, in accordance with the U.S. Pat. No. 50,278,693, a polymer acting as a thickener is introduced into the medium.

Many patents for improvements have been filed, that relate to means for increasing the viscosity of the active gel. Some of them, such as European Patent Application EP 1 560 064 A1 and international Application PCT WO 2004/085567 A2, propose the use of polymer beads in the active medium in order to easily fill the aquarium, then heating at 80° C. to dissolve the polymer beads and render the active medium transparent and in principle solid. In fact, it is possible to qualify the consistency of the resulting medium as “quasi-solid” only. Furthermore, the difficulties of having to manufacture the aquarium and having to fill it remain.

It is sought, in a general manner, to obtain electrically controllable devices having:
a good mechanical strength of the electroactive layer;
a coloring-bleaching rate that is as fast as possible;
a coloring-bleaching transition that is as homogeneous as possible, namely without a coloring gradient from the edges towards the centre (halo effect) and without zones that do not have any coloring (pinholes); and
a high contrast between the colored state and the bleached state.

The Applicant company has discovered on this occasion that by combining the two electrochromic materials having complementary anodic and cathodic colorations, more generally compounds having redox activities that are respectively positive and negative, within a self-supporting electrolyte layer, twice as many charges will be used for the coloring/bleaching processes to obtain the same levels of coloring and of bleaching than in the case where the electrolyte only contained a single electrochromic material, and a novel electro-active system structure is obtained which has a good mechanical strength and which allows coloring at a lower voltage. The components of the electrically controllable device: transparent conductive oxide layers, solubilization liquid of the ionic charges, polymer matrix, etc., then functioning at a lower voltage, are less stressed, which has the effect of increasing the durability of the electrically controllable device.

U.S. Pat. No. 6,620,342 A1 describes a RECLT (electrically controllable light transmission) film comprising a film of polyvinylidene fluoride combined with an electrolyte and functionally associated with a RECLT material which may be an electrochromic material such as ferrocene or a 4,4′-dipyridinium compound. However, this document does not describe a RECLT film containing both an organic electrochromic compound having cathodic coloration and an organic electrochromic compound having anodic coloration.

One subject of the present invention is therefore an electroactive material of an electrically controllable device having variable optical/energy properties, characterized in that it comprises a self-supporting polymer matrix, inserted into which is an electroactive system comprising or constituted by:
at least one electroactive organic compound capable of being reduced and/or of accepting electrons and cations acting as compensation charges;
at least one electroactive organic compound capable of being oxidized and/or of ejecting electrons and cations acting as compensation charges;
at least one of said electroactive organic compounds capable of being reduced and/or of accepting electrons and cations acting as compensation charges or capable of being oxidized and/or of ejecting electrons and cations acting as compensation charges being electrochromic in order to obtain a color contrast,
ionic charges;
   and also a solubilization liquid for said electroactive system, said liquid not dissolving said self-supporting polymer matrix, the latter being chosen to provide a percolation pathway for ionic charges, this allowing, under the action of a dielectric current, oxidation and reduction reactions of said electroactive organic compounds, which reactions are necessary to obtain a color contrast.

The expression “cations acting as compensation charges” is understood to mean the Li⁺, H⁺, etc. ions which may be inserted into or ejected from the electroactive compounds at the same time as the electrons.

The expression “electroactive organic compound capable of being oxidized and/or of ejecting electrons and cations acting as compensation charges” is understood to mean a compound having a positive redox activity, which may be an electrochrome with anodic coloration or a non-electrochromic compound, then only acting as an ionic charge reservoir or a counterelectrode.

The expression “electroactive organic compound capable of being reduced and/or of accepting electrons and cations acting as compensation charges”, is understood to mean a compound having a negative redox activity, which may be an electrochrome with cathodic coloration or a non-electrochromic compound, then acting only as an ionic charge reservoir or a counterelectrode.

The ionic charges may be carried by at least one of said electroactive organic compound or compounds and/or by at least one ionic salt and/or at least one acid dissolved in said liquid and/or by said self-supporting polymer matrix.

The solubilization liquid may be made up of a solvent or a mixture of solvents and/or of at least one ionic liquid or ambient-temperature molten salt, said ionic liquid(s) or molten salt(s) then constituting a solubilization liquid bearing ionic charges, which represent all or some of the ionic charges of said electroactive system.

The electroactive organic compound or compounds capable of being reduced and/or of accepting electrons and cations acting as compensation charges may be chosen from bipyridiniums or viologens such as 1,1′-diethyl-4,4′-bipyridinium diperchlorate, pyraziniums, pyrimidiniums, quinoxaliniums, pyryliums, pyridiniums, tetrazoliums, verdazyls, quinones, quinodimethanes, tricyanovinylbenzenes, tetracyanoethylene, polysulfides and disulfides, and also all the electroactive polymer derivatives of the electroactive compounds which have just been mentioned. As examples of the above polymer derivatives, mention may be made of polyviologens.

The electroactive organic compound or compounds capable of being oxidized and/or of ejecting electrons and cations acting as compensation charges may be chosen from metallocenes, such as cobaltocenes, ferrocenes, N,N,N′,N′-tetramethylphenylenediamine (TMPD), phenothiazines such as phenothiazine, dihydrophenazines such as 5,10-dihydro-5,10-dimethylphenazine, reduced methylphenothiazone (MPT), methylene violet bernthsen (MVB), verdazyls, and also all the electroactive polymer derivatives of the electroactive compounds which have just been mentioned.

The ionic salt or salts may be chosen from lithium perchlorate, trifluoromethanesulfonate or triflate salts, trifluoromethanesulfonylimide salts and ammonium salts.

The acid or acids may be chosen from sulfuric acid (H₂SO₄), triflic acid (CF₃SO₃H), phosphoric acid (H₃PO₄) and polyphosphoric acid (Hₙ₊₂PₙO₃ₙ₊₁). The concentration of the ionic salt or salts and/or of the acid or acids in the solvent or the mixture of solvents is especially less than or equal to 5 mol/l, preferably less than or equal to 2 mol/l, even more preferably less than or equal to 1 mol/1.

The or each solvent may be chosen from those having a boiling point at least equal to 95° C., preferably at least equal to 150° C.

The solvent or solvents may be chosen from dimethylsulfoxide, N,N-dimethylformamide, N,N-dimethylacetamide, propylene carbonate, ethylene carbonate, N-methyl-2-pyrrolidone (1-methyl-2-pyrrolidinone), γ-butyrolactone, ethylene glycols, alcohols, ketones, nitriles and water.

The ionic liquid or liquids may be chosen from imidazolium salts, such as 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethyl-sulfonyl)imide (emim-N(CF₃SO₂)₂ or emim-TSFI) and 1-butyl-3-methylimidazolium bis(trifluoromethyl-sulfonyl)imide (bmim-N(CF₃SO₂)₂ or bmim-TSFI).

The self-supporting polymer matrix may be composed of at least one polymer layer in which said liquid has penetrated to the core.

The polymer or polymers of the matrix and the liquid may be chosen so that the self-supporting active medium withstands a temperature corresponding to the temperature necessary for a subsequent laminating or calendering step, namely a temperature of at least 80° C., in particular of at least 100° C.

The polymer constituting at least one layer may be a homopolymer or copolymer that is in the form of a nonporous film but is capable of swelling in said liquid.

The film has, in particular, a thickness of less than 1000 μm, preferably of 10 to 500 μm, more preferably of 50 to 120 μm.

The polymer constituting at least one layer may also be a homopolymer or copolymer that is in the form of a porous film, said porous film being optionally capable of swelling in the liquid comprising ionic charges and of which the porosity after swelling is chosen to allow the percolation of ionic charges in the thickness of the liquid-impregnated film.

Said film then has, in particular, a thickness of less than 1000 μm, preferably less than 800 μm, more preferably of 10 to 500 μm, and more preferably still of 50 to 120 μm.

Furthermore, the polymer or polymers of the polymer matrix are advantageously chosen in order to be able to withstand the conditions of laminating and calendering, optionally with heating.

The polymer material constituting at least one layer may be chosen from:
homopolymers or copolymers that do not comprise ionic charges, in which case these charges are carried by at least one aforementioned electroactive organic compound and/or by at least one ionic salt or dissolved acid and/or by at least one ionic liquid or molten salt;
homopolymers or copolymers comprising ionic charges, in which case supplementary charges that make it possible to increase the percolation rate may be carried by at least one aforementioned electroactive organic compound and/or by at least one ionic salt or dissolved acid and/or by at least one ionic liquid or molten salt; and
blends of at least one homopolymer or copolymer that do not comprise ionic charges and of at least one homopolymer or copolymer comprising ionic charges, in which case supplementary charges that make it possible to increase the percolation rate may be carried by at least one aforementioned electroactive organic compound and/or by at least one ionic salt or dissolved acid and/or by at least one ionic liquid or molten salt.

The polymer matrix may be made up of a film based on a homopolymer or copolymer comprising ionic charges, capable of giving, by itself, a film essentially capable of providing the desired percolation rate for the electroactive system or a percolation rate greater than this and on a homopolymer or copolymer that may or may not comprise ionic charges, capable of giving, by itself, a film that does not necessarily make it possible to provide the desired percolation rate, but that is essentially capable of ensuring the mechanical behavior, the contents of each of these two homopolymers or copolymers being adjusted so that both the desired percolation rate and the mechanical behavior of the resulting self-supporting organic active medium are ensured.

The polymer or polymers of the polymer matrix that do not comprise ionic charges may be chosen from copolymers of ethylene, of vinyl acetate and optionally of at least one other comonomer, such as ethylene/vinyl acetate copolymers (EVA); polyurethane (PU); polyvinyl butyral (PVB); polyimides (PI); polyamides (PA); polystyrene (PS); polyvinylidene fluoride (PVDF); polyetheretherketones (PEEK); polyethylene oxide (POE); epichlorohydrin copolymers and polymethyl methacrylate (PMMA).

The polymers are chosen from the same family whether they are prepared in the form of porous or nonporous films, the porosity being provided by the pore-forming agent used during the manufacture of the film.

As polymers that are preferred in the case of the nonporous film, mention may be made of polyurethane (PU) or ethylene/vinyl acetate copolymers (EVA).

As polymers that are preferred in the case of the porous film, mention may be made of polyvinylidene fluoride.

The polymer or polymers of the polymer matrix bearing ionic charges or polyelectrolytes may be chosen from sulfonated polymers which have undergone an exchange of the H⁺ ions of the SO₃H groups with the ions of the desired ionic charges, this ion exchange having taken place before and/or at the same time as the swelling of the polyelectrolyte in the liquid comprising ionic charges.

The sulfonated polymer may be chosen from sulfonated copolymers of tetrafluoroethylene, polystyrene sulfonates (PSS), copolymers of sulfonated polystyrene, poly(2-acrylamido-2-methyl-1-propanesulfonic acid) (PAMPS), sulfonated polyetheretherketones (PEEK) and sulfonated polyimides.

The support may comprise from one to three layers.

When the support comprises at least two layers, a stack of at least two layers may have been formed from electrolyte and/or non-electrolyte polymer layers before penetration of the liquid to the core, then has been swollen by said liquid.

When the support comprises three layers, the two outer layers of the stack may be layers having low swelling in order to favor the mechanical behavior of said material and the central layer is a layer having high swelling to favor the percolation rate of the ionic charges.

The self-supporting polymer matrix may be nanostructured by the incorporation of nanoparticles of fillers or inorganic nanoparticles, in particular SiO₂ nanoparticles, especially in an amount of a few percent relative to the mass of polymer in the support. This makes it possible to improve certain properties of said support such as the mechanical strength.

Another subject of the present invention is a process for manufacturing an electroactive material as defined above, characterized in that polymer granules are mixed with a solvent and, if it is desired to manufacture a porous polymer matrix, a pore-forming agent, the resulting formulation is cast on a support and after evaporation of the solvent, the pore-forming agent is removed by washing in a suitable solvent for example if this agent has not been removed during the evaporation of the aforementioned solvent, the resulting self-supporting film is removed, then said film is impregnated with the solubilization liquid of the electroactive system, and then a draining operation is carried out, where appropriate.

The immersion can be carried out for a time period of 2 minutes to 3 hours. The immersion can be carried out with heating, for example at a temperature of 40 to 80° C.

It is also possible to carry out the immersion with the application of ultrasounds to aid the penetration of the solubilization liquid into the matrix.

Equally, another subject of the present invention is a kit for manufacturing the electroactive material as defined above, characterized in that it consists of:
a self-supporting polymer matrix as defined above; and
a solubilization liquid of the electroactive system as defined above, in which said electroactive system has been dissolved.

A subject of the present invention is also an electrically controllable device having variable optical/energy properties, comprising the following stack of layers:
a first substrate having a glass function;
a first electronically conductive layer with an associated current feed;
an electroactive system;
a second electronically conductive layer with an associated current feed; and
a second substrate having a glass function, characterized in that the electroactive system is as defined above.

The substrates having a glass function are especially chosen from glass (float glass, etc.) and transparent polymers, such as polymethyl methacrylate (PMMA), polycarbonate (PC), polyethylene terephthalate (PET), polyethylene naphthoate (PEN) and cycloolefin copolymers (COCs).

The electronically conductive layers are especially layers of metallic type, such as layers of silver, of gold, of platinum and of copper; or layers of transparent conductive oxide (TCO) type, such as layers of tin-doped indium oxide (In₂O₃:Sn or ITO), of antimony-doped indium oxide (In₂O₃:Sb), of fluorine-doped tin oxide (SnO₂:F) and of aluminum-doped zinc oxide (ZnO:Al); or multilayers of the TCO/metal/TCO type, the TCO and the metal being especially chosen from those listed above; or multilayers of the NiCr/metal/NiCr type, the metal especially being chosen from those listed above.

When the electrochromic system is intended to work in transmission, the electrically conductive materials are generally transparent oxides for which the electronic conduction has been amplified by doping, such as In₂O₃:Sn, In₂O₃:Sb, ZnO:Al or SnO₂:F. Tin-doped indium oxide (In₂O₃:Sn or ITO) is frequently used for its high electronic conductivity properties and its low light absorption. When the system is intended to work in reflection, one of the electrically conductive materials may be of metallic nature.

The electrically controllable device may be configured to form:
a sunroof for a motor vehicle, that can be activated autonomously, or a side window or a rear window for a motor vehicle or a rear-view mirror;
a windshield or a portion of a windshield of a motor vehicle, of an aircraft, of a ship, a vehicle sunroof;
a glazing unit for cranes, construction site vehicles or tractors;
an aircraft cabin window;
a display panel for displaying graphical and/or alphanumeric information;
an interior or exterior glazing unit for buildings;
a skylight;
a display cabinet or store counter;
a glazing unit for protecting objects of the painting type;
an anti-glare computer screen;
glass furniture; and
a wall for separating two rooms inside a building.

The electrically controllable device according to the invention may operate in transmission or in reflection.

The substrates may be transparent, flat or curved, clear or bulk-tinted, opaque or opacified, of polygonal shape or at least partially curved.

At least one of the substrates may incorporate another functionality such as a solar control, antireflection or self-cleaning functionality.

Another subject of the present invention is a process for manufacturing the electrically controllable device as defined above, characterized in that the various layers which form it are assembled by calendering or laminating, optionally with heating.

The present invention finally relates to a single or multiple glazing unit, characterized in that it comprises an electrically controllable device as defined above.

The various layers making up said system can be assembled as a single or multiple glazing unit.

The following examples illustrate the present invention without however limiting the scope thereof. In these examples, the following abbreviations have been used:
PVDF: polyvinylidene fluoride
ITO: tin-doped indium oxide In₂O₃:Sₙ
PU: polyurethane
EVA: ethylene/vinyl acetate copolymer

The K-glass™ glass used in these examples is a glass covered with an electrically conductive layer of SnO₂:F (glass sold under this name by Pilkington).

In order to prepare the PVDF films, the polyvinylidene fluoride powder manufactured by Arkema under the name Kynar® LGB1 was used.

A PU film having a thickness of 100 microns, made from a Tecolflex™ resin sold by Noveon, was used.

### EXAMPLE 1

### Preparation of an Electrochromic Cell

glass having a layer of SnO₂:F;
electroactive system: PVDF+ferrocene+1,1′-diethyl-4,4′-bipyridinium diperchlorate+lithium perchlorate+propylene carbonate; and
glass having a layer of SnO₂:F.

A self-supporting film of PVDF was manufactured by mixing 3.5 g of PVDF powder, 6.5 g of dibutyl phthalate and 15 g of acetone. The formulation was stirred for two hours, and it was cast on a sheet of glass. After evaporation of the solvent, the PVDF film was removed from the glass sheet under a trickle of water.

An electrolyte solution was prepared by mixing 0.09 g of ferrocene, 0.21 g of 1,1′-diethyl-4,4′-bipyridinium diperchlorate and 0.20 g of lithium perchlorate in 20 ml of propylene carbonate. The solution was stirred for 1 hour.

The PVDF film having a thickness of around 80 microns was immersed in diethyl ether (to dissolve the dibutyl phthalate) for 5 minutes, then in the electrolyte solution for 5 minutes before being deposited onto a sheet of K-glass. A second sheet of K-glass was deposited on the electrolyte-impregnated film, and clamps were used to ensure good contact between the glass and the film.

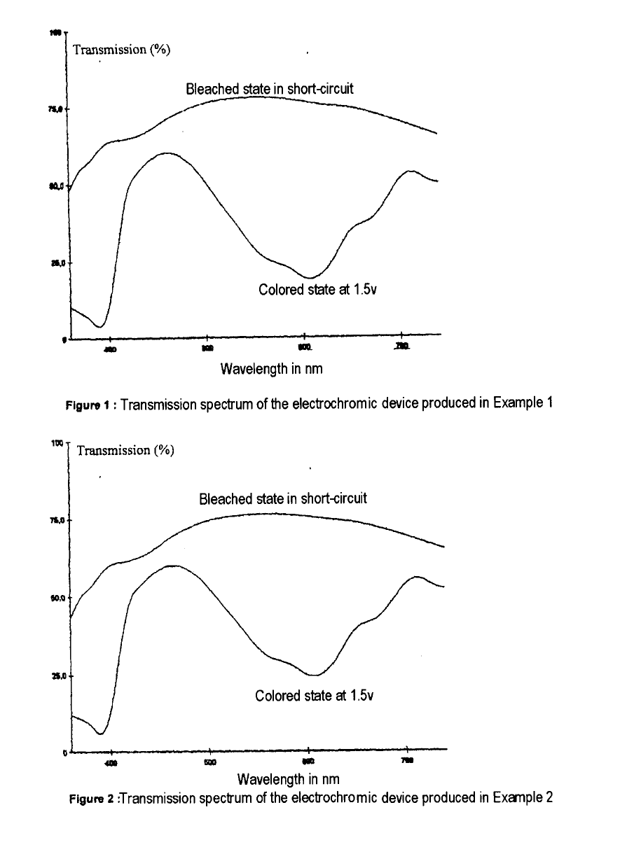

The electrochromic device thus manufactured, of which the transmission spectrum in the visible range presented in FIG. 1 shows a change in the optical properties of the device under application of an electric field, had a light transmission of 77% under a short circuit, and of 33% under a voltage of 1.5 V.

### EXAMPLE 2

### Preparation of an Electrochromic Cell

glass having a layer of SnO₂:F
electroactive system from Example 1, the PVDF having been nanostructured by SiO₂; and
glass having a layer of SnO₂:F

A self-supporting film of PVDF was manufactured by mixing 3.25 g of PVDF powder, 6.5 g of dibutyl phthalate, 0.25 g of SiO₂ nanoparticles having a diameter of 15 nm and 15 g of acetone. The formulation was stirred for two hours and it was cast on a sheet of glass. After evaporation of the solvent, the PVDF film was removed from the glass sheet under a trickle of water.

An electrolyte solution was prepared by mixing 0.09 g of ferrocene, 0.21 g of 1,1′-diethyl-4,4′-bipyridinium diperchlorate and 0.20 g of lithium perchlorate in 20 ml of propylene carbonate. The solution was stirred for 1 hour.

The PVDF film having a thickness of around 80 microns was immersed in diethyl ether for 5 minutes then in the electrolyte solution for 5 minutes before being deposited onto a sheet of K-glass. A second sheet of K-glass was deposited on the electrolyte-impregnated film, and clamps were used to ensure good contact between the glass and the film.

The electrochromic device thus manufactured, of which the transmission spectrum in the visible range presented in FIG. 2 shows a change in the optical properties of the device under application of an electric field had a light transmission of 75% under a short circuit and of 37% under a voltage of 1.5 V.

### EXAMPLE 3

### Preparation of an Electrochromic Cell

glass having a layer of SnO₂:F
electroactive system from Example 1, the PVDF having been nanostructured by SiO₂; and
glass having a layer of SnO₂:F

A self-supporting film of PVDF was manufactured by mixing 3.25 g of PVDF powder, 6.5 g of dibutyl phthalate, 0.25 g of SiO₂ nanoparticles having a diameter of 15 nm and 15 g of acetone. The formulation was stirred for two hours and it was cast on a sheet of glass. After evaporation of the solvent, the PVDF film was removed from the glass sheet under a trickle of water.

An electrolyte solution was prepared by mixing 0.09 g of ferrocene, 0.21 g of 1,1′-diethyl-4,4′-bipyridinium diperchlorate and 0.20 g of lithium perchlorate in 80 ml of propylene carbonate. The solution was stirred for 1 hour.

The PVDF film having a thickness of around 80 microns was immersed in diethyl ether for 5 minutes then in the electrolyte solution for 5 minutes before being deposited onto a sheet of glass covered with SnO₂:F. A second sheet of glass covered with SnO₂:F was deposited on the electrolyte-impregnated film, and clamps were used to ensure good contact between the glass and the film.

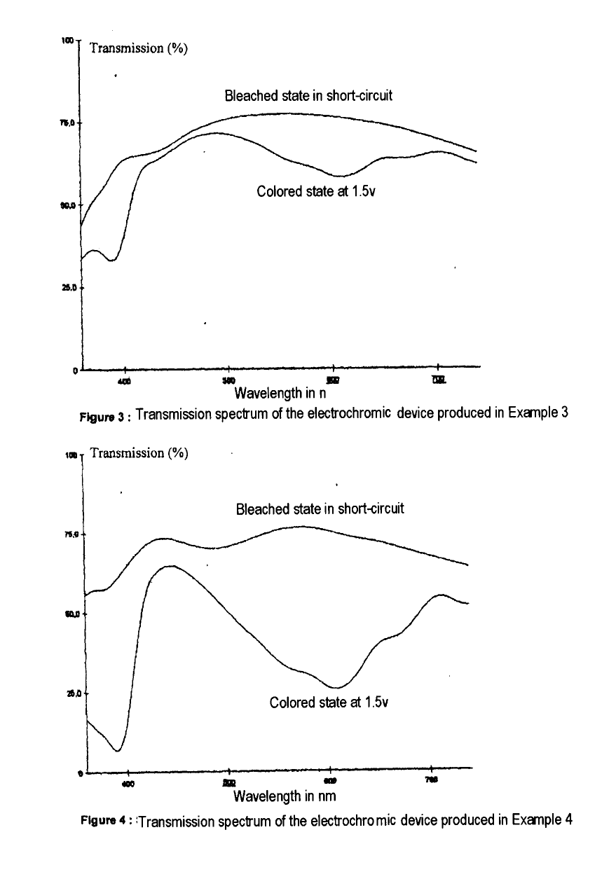

The electrochromic device thus manufactured, of which the transmission spectrum in the visible range presented in FIG. 3 shows a change in the optical properties of the device under application of an electric field had a light transmission of 76% under a short circuit and of 64% under a voltage of 1.5 V.

### EXAMPLE 4

### Preparation of an Electrochromic Cell

glass having a layer of ITO
electroactive system from Example 1, the PVDF having been nanostructured by SiO₂; and
glass having a layer of ITO

A self-supporting film of PVDF was manufactured by mixing 3.25 g of PVDF powder, 6.5 g of dibutyl phthalate, 0.25 g of SiO₂ nanoparticles having a diameter of 15 nm and 15 g of acetone. The formulation was stirred for two hours and it was cast on a sheet of glass. After evaporation of the solvent, the PVDF film was removed from the glass sheet under a trickle of water.

An electrolyte solution was prepared by mixing 0.09 g of ferrocene, 0.21 g of 1,1′-diethyl-4,4′-bipyridinium diperchlorate and 0.20 g of lithium perchlorate in 20 ml of propylene carbonate. The solution was stirred for 1 hour.

The PVDF film having a thickness of around 80 microns was immersed in diethyl ether for 5 minutes then in the electrolyte solution for 5 minutes before being deposited onto a sheet of glass covered with ITO. A second sheet of glass covered with ITO was deposited on the electrolyte-impregnated film, and clamps were used to ensure good contact between the glass and the film.

The electrochromic device thus manufactured, of which the transmission spectrum in the visible range presented in FIG. 4 shows a change in the optical properties of the device under application of an electric field had a light transmission of 74% under a short circuit and of 38% under a voltage of 1.5 V.

### EXAMPLE 5

### Preparation of an Electrochromic Cell

glass having a layer of SnO₂:F
electroactive system: PVDF nanostructured by SiO₂+5,10-dihydro-5,10-dimethylphenazine+1,1′-diethyl-4,4′-bipyridinium diperchlorate+lithium perchlorate+propylene carbonate; and
glass having a layer of SnO₂:F

A self-supporting film of PVDF was manufactured by mixing 3.25 g of PVDF powder, 6.5 g of dibutyl phthalate, 0.25 g of SiO₂ nanoparticles having a diameter of 15 nm and 15 g of acetone. The formulation was stirred for two hours and it was cast on a sheet of glass. After evaporation of the solvent, the PVDF film was removed from the glass sheet under a trickle of water.

An electrolyte solution was prepared by mixing 0.11 g of 5,10-dihydro-5,10-dimethylphenazine, 0.20 g of 1,1′-diethyl-4,4′-bipyridinium diperchlorate and 0.16 g of lithium perchlorate in 20 ml of propylene carbonate. The solution was stirred for 1 hour.

The PVDF film having a thickness of around 80 microns was immersed in diethyl ether for 5 minutes then in the electrolyte solution for 5 minutes before being deposited onto a sheet of K-glass. A second sheet of K-glass was deposited on the electrolyte-impregnated film, and clamps were used to ensure good contact between the glass and the film.

The electrochromic device thus manufactured, of which the transmission spectrum in the visible range presented in FIG. 5 shows a change in the optical properties of the device under application of an electric field had a light transmission of 72% under a short circuit and of 40% under a voltage of 1.5 V.

### EXAMPLE 6

### Preparation of an Electrochromic Cell

glass having a layer of SnO₂:F
electroactive system: PVDF nanostructured by SiO₂+N,N,N′,N′-tetramethyl-p-phenylenediamine+1,1′-diethyl-4,4′-bipyridinium diperchlorate+lithium perchlorate+propylene carbonate; and
glass having a layer of SnO₂:F

A self-supporting film of PVDF was manufactured by mixing 3.25 g of PVDF powder, 6.5 g of dibutyl phthalate, 0.25 g of SiO₂ nanoparticles having a diameter of 15 nm and 15 g of acetone. The formulation was stirred for two hours and it was cast on a sheet of glass. After evaporation of the solvent, the PVDF film was removed from the glass sheet under a trickle of water.

An electrolyte solution was prepared by mixing 0.08 g of N,N,N′,N′-tetramethyl-p-phenylenediamine, 0.20 g of 1,1′-diethyl-4,4′-bipyridinium diperchlorate and 0.16 g of lithium perchlorate in 20 ml of propylene carbonate. The solution was stirred for 1 hour.

The PVDF film having a thickness of around 80 microns was immersed in diethyl ether for 5 minutes then in the electrolyte solution for 5 minutes before being deposited onto a sheet of K-glass. A second sheet of K-glass was deposited on the electrolyte-impregnated film, and clamps were used to ensure good contact between the glass and the film.

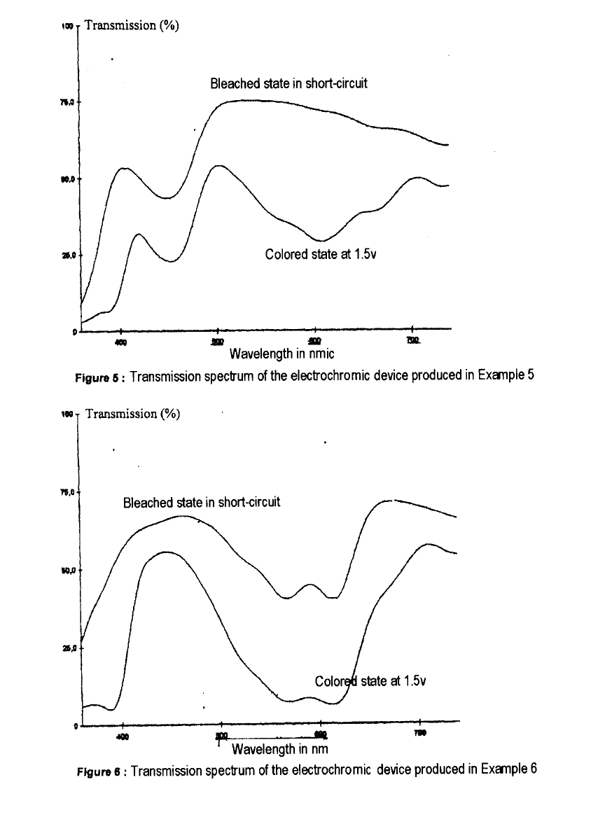

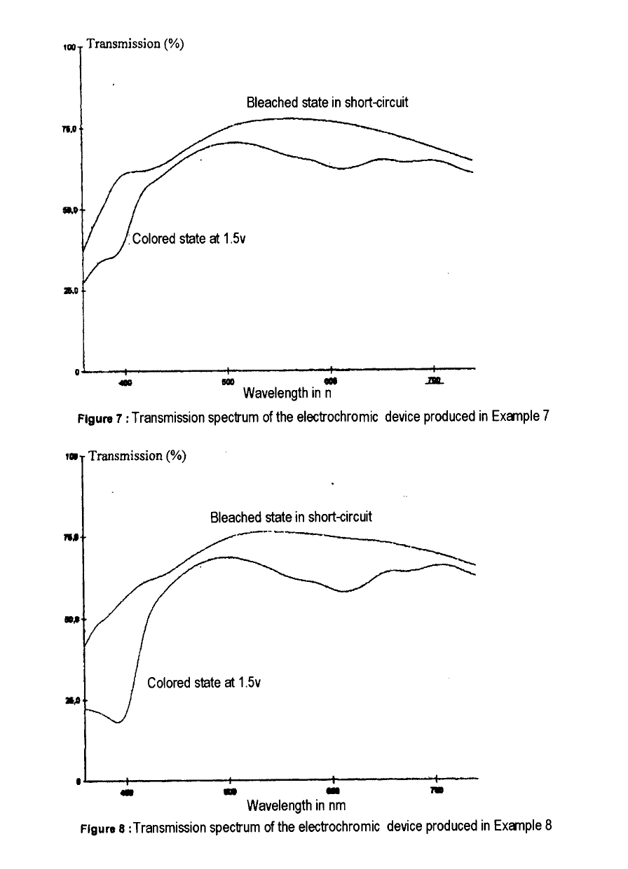

The electrochromic device thus manufactured, of which the transmission spectrum in the visible range presented in FIG. 6 shows a change in the optical properties of the device under application of an electric field had a light transmission of 49% under a short circuit and of 17% under a voltage of 1.5 V.

### EXAMPLE 7

### Preparation of an Electrochromic Cell

glass having a layer of SnO₂:F
electroactive system: PU+ferrocene+1,1′-diethyl-4,4′-bipyridinium diperchlorate+lithium perchlorate+propylene carbonate/1-methyl-2-pyrrolidinone; and
glass having a layer of SnO₂:F

An electrolyte solution was prepared by mixing 0.12 g of ferrocene, 0.26 g of 1,1′-diethyl-4,4′-bipyridinium diperchlorate and 0.13 g of lithium perchlorate in 25 ml of an 80/20 mixture of propylene carbonate and 1-methyl-2-pyrrolidinone. The solution was stirred for 1 hour.

A PU film having a thickness of 100 microns was impregnated for 2 hours by dipping in the electrolyte solution before being deposited on a sheet of K-glass. A second sheet of K-glass was deposited on the electrolyte-impregnated film, and clamps were used to ensure good contact between the glass and the film.

The electrochromic device thus manufactured, of which the transmission spectrum in the visible range presented in FIG. 7 shows a change in the optical properties of the device under application of an electric field, had a light transmission of 76% under a short circuit and of 66% under a voltage of 1.5 V.

### EXAMPLE 8

### Preparation of an Electrochromic Cell

glass having a layer of SnO₂:F
electroactive system: EVA+ferrocene+1,1′-diethyl-4,4′-bipyridinium diperchlorate+lithium perchlorate+1-methyl-2-pyrrolidinone; and
glass having a layer of SnO₂:F

An electrolyte solution was prepared by mixing 0.19 g of ferrocene, 0.41 g of 1,1′-diethyl-4,4′-bipyridinium diperchlorate and 0.21 g of lithium perchlorate in 40 ml of 1-methyl-2-pyrrolidinone. The solution was stirred for 1 hour.

An EVA film having a thickness of 200 microns was impregnated for 1 hour in the electrolyte solution before being deposited on a sheet of K-glass. A second sheet of K-glass was deposited on the electrolyte-impregnated film, and clamps were used to ensure good contact between the glass and the film.

The electrochromic device thus manufactured, of which the transmission spectrum in the visible range presented in FIG. 8 shows a change in the optical properties of the device under application of an electric field, had a light transmission of 75% under a short circuit and of 63% under a voltage of 1.5 V.

1. An electroactive material of an electrically controllable device having variable optical/energy properties, comprising a self-supporting polymer matrix, inserted into which is an electroactive system comprising:
at least one electroactive organic compound capable of being reduced or of accepting electrons and cations acting as compensation charges, or both;
at least one electroactive organic compound capable of being oxidized or of ejecting electrons and cations acting as compensation charges, or both;
at least one of said electroactive organic compounds capable of being reduced or of accepting electrons and cations acting as compensation charges or both, or capable of being oxidized or of ejecting electrons and cations acting as compensation charges, or both, being electrochromic in order to obtain a color contrast,
ionic charges;
and also a solubilization liquid for said electroactive system, said liquid not dissolving said self-supporting polymer matrix, the latter being chosen to provide a percolation pathway for ionic charges, this allowing, under the action of a dielectric current, oxidation and reduction reactions of said electroactive organic compounds, wherein said reactions are necessary to obtain a color contrast.

2. The electroactive material as claimed in claim 1, wherein the electroactive organic compound capable of being reduced or of accepting electrons and cations acting as compensation charges or both is at least one of a bipyridinium or viologen selected from the group consisting of 1,1′-diethyl-4,4′-bipyridinium diperchlorate, pyrazinium, pyrimidinium, quinoxalinium, pyrylium, pyridinium, tetrazolium, verdazyl, quinone, quinodimethane, tricyanovinylbenzene, tetracyanoethylene, polysulfide, and disulfide, and also all the electroactive polymer derivatives of the electroactive compounds which have just been mentioned, and the electroactive organic compound capable of being oxidized or of ejecting electrons and cations acting as compensation charge or both, is at least one selected from the group consisting of a metallocene, N,N,N′,N′-tetramethylphenylenediamine (TMPD), a phenothiazine, dihydrophenazine, reduced methylphenothiazone (MPT), methylene violet bernthsen (MVB), a verdazyl, and also all the electroactive polymer derivatives of the electroactive compounds which have just been mentioned.

3. The electroactive material as claimed in claim 1, wherein the ionic charges are borne by at least one of said electroactive organic compounds or at least one ionic salt or at least one acid dissolved in said liquid or by said self-supporting polymer matrix, or mixtures thereof, wherein the ionic salt is lithium perchlorate salt, or trifluoromethanesulfonate salt, or triflate salt, or trifluoromethanesulfonylimide salt or ammonium salt, or mixtures thereof, and the acid is sulfuric acid (H₂SO₄), or triflic acid (CF₃SO₃H), or phosphoric acid (H₃PO₄) or polyphosphoric acid (Hₙ₊₂PₙO₃ₙ₊₁), or mixtures thereof.

4. The electroactive material as claimed in claim 1, wherein the solubilization liquid comprises at least one solvent or at least one ionic liquid or ambient-temperature molten salt, or a mixture thereof, said ionic liquid or molten salt comprising a solubilization liquid bearing ionic charges, which represent all or some of the ionic charges of said electroactive system, the solvent being at least one selected from the group consisting of dimethylsulfoxide, N,N-dimethylformamide, N,N-dimethylacetamide, propylene carbonate, ethylene carbonate, N-methyl-2-pyrrolidone (1-methyl-2-pyrrolidinone), γ-butyrolactone, ethylene glycol, alcohol, ketone, nitrile and water, and the ionic liquid being selected from the group of imidazolium salts consisting of 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethylsulfonyl)imide, (emim-N(CF₃SO₂)₂ or emim-TSFI) and 1-butyl-3-methylimidazolium bis(trifluoromethylsulfonyl)imide (bmim-N(CF₃SO₂)₂ or bmim-TSFI).

5. The electroactive material as claimed in claim 1, wherein the self-supporting polymer matrix is composed of at least one polymer layer in which said liquid has penetrated to the core, the polymer comprising at least one layer being a homopolymer or copolymer that is in the form of a nonporous film but is capable of swelling in said liquid, or that is in the form of a porous film, said porous film optionally being capable of swelling in the liquid comprising ionic charges and of which the porosity after swelling is chosen to allow the percolation of the ionic charges into the thickness of the liquid-impregnated film.

6. The electroactive material as claimed in claim 5, wherein the polymer material comprising at least one layer is chosen from:
at least one homopolymer or at least one copolymer, or mixtures thereof, that do not comprise ionic charges, in which case these charges are carried by at least one aforementioned electroactive organic compound or by at least one ionic salt or dissolved acid or by at least one ionic liquid or molten salt, or mixtures thereof;
at least one homopolymer or at least one copolymer, or mixtures thereof, comprising ionic charges, in which case supplementary charges that make it possible to increase the percolation rate may be carried by at least one aforementioned electroactive organic compound or by at least one ionic salt or dissolved acid or by at least one ionic liquid or molten salt, or mixtures thereof; and
blends of at least one homopolymer or copolymer that do not comprise ionic charges and of at least one homopolymer or copolymer comprising ionic charges, in which case supplementary charges that make it possible to increase the percolation rate may be carried by at least one aforementioned electro-active organic compound or by at least one ionic salt or dissolved acid or by at least one ionic liquid or molten salt, or mixtures thereof.

7. The electroactive material as claimed in claim 1, wherein the polymer matrix comprises a film based on a homopolymer or copolymer comprising ionic charges, capable of giving, by itself, a film essentially capable of providing the desired percolation rate for the electroactive system or a percolation rate greater than this and on a homopolymer or copolymer that may or may not comprise ionic charges, the contents of each of these two homopolymers or copolymers being adjusted so that both the desired percolation rate and the mechanical behavior of the resulting self-supporting organic active medium are ensured.

8. The electroactive material as claimed in claim 6, wherein at least one homopolymer or at least one copolymer, or mixtures thereof, of the polymer matrix that do not comprise ionic charges is at least one selected from the group consisting of copolymer of ethylene, copolymer of vinyl acetate, and copolymer of vinyl acetate and at least one other comonomer, wherein the other comonomer is at least one selected from the group consisting of ethylene/vinyl acetate copolymer (EVA); polyurethane (PU); polyvinyl butyral (PVB); polyimide (PI); polyamide (PA); polystyrene (PS); polyvinylidene fluoride (PVDF); polyetheretherketone (PEEK); polyethylene oxide (POE); epichlorohydrin copolymer, polymethyl methacrylate (PMMA); and the polymer of the polymer matrix bearing ionic charges or polyelectrolyte is a sulfonated polymer which has undergone an exchange of the H⁺ ions of the SO₃H groups with the ions of the desired ionic charges, this ion exchange having taken place before or at the same time as the swelling of the polyelectrolyte in the liquid comprising ionic charges, or both, where the sulfonated polymer is selected from the group consisting of sulfonated copolymer of tetrafluoroethylene, polystyrene sulfonate (PSS), a copolymer of sulfonated polystyrene, poly(2-acrylamido-2-methyl-1-propanesulfonic acid) (PAMPS), sulfonated polyetheretherketone (PEEK) and sulfonated polyimide.

9. The electroactive material as claimed in claim 1, wherein the support comprises at least two layers, wherein a stack of at least two layers has been formed from electrolyte or non-electrolyte polymer layers, or mixtures thereof, before penetration of the liquid to the core, that has been swollen by said liquid.

10. The electroactive material as claimed in claim 1, wherein the support comprises three layers, wherein the two outer layers of the stack are layers having low swelling in order to favor the mechanical behavior of said material and the central layer is a layer having high swelling to favor the percolation rate of the ionic charges.

11. The electroactive material as claimed in claim 1, wherein the self-supporting polymer matrix is nanostructured by the incorporation of nanoparticles of fillers or inorganic nanoparticles.

12. A process for manufacturing an electroactive material as defined in claim 1, comprising
mixing polymer granules with a solvent and, if it is desired to manufacture a porous polymer matrix, a pore-forming agent,
casting the resulting formulation is cast on a support and after evaporation of the solvent,
removing the pore-forming agent by washing in a suitable solvent for example if this agent has not been removed during the evaporation of the aforementioned solvent, the resulting self-supporting film is removed, then said film is impregnated with the solubilization liquid of the electroactive system, and then a draining operation is carried out, where appropriate.

13. A kit for manufacturing the electroactive material as defined in claim 1, comprising:
a self-supporting polymer matrix composed of at least one polymer layer in which said liquid has penetrated to the core, the polymer comprising at least one layer being a homopolymer or copolymer that is in the form of a nonporous film but is capable of swelling in said liquid, or that is in the form of a porous film, said porous film optionally being capable of swelling in the liquid comprising ionic charges and of which the porosity after swelling is chosen to allow the percolation of the ionic charges into the thickness of the liquid-impregnated film; and
a solubilization liquid of the electroactive system comprising at least one solvent or at least one ionic liquid or ambient-temperature molten salt, or a mixture thereof, said ionic liquid or molten salt comprising a solubilization liquid bearing ionic charges, which represent all or some of the ionic charges of said electroactive system, the solvent being at least one selected from the group consisting of dimethylsulfoxide, N,N-dimethylformamide, N,N-dimethylacetamide, propylene carbonate, ethylene carbonate, N-methyl-2-pyrrolidone (1-methyl-2-pyrrolidinone), γ-butyrolactone, ethylene glycol, alcohol, ketone, nitrile and water, and the ionic liquid being selected from the group of imidazolium salts consisting of 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethylsulfonyl)imide, (emim-N(CF₃SO₂)₂ or emim-TSFI) and 1-butyl-3-methylimidazolium bis(trifluoromethylsulfonyl)imide (bmim-N(CF₃SO₄)₂ or bmim-TSFI), in which said electroactive system has been dissolved.

14. An electrically controllable device having variable optical/energy properties, operating especially in transmission or in reflection, comprising the following stack of layers:
a first substrate having a glass function;
a first electronically conductive layer with an associated current feed;
an electroactive system;
a second electronically conductive layer with an associated current feed; and
a second substrate having a glass function,
the substrates especially being transparent, flat or curved, clear or bulk-tinted, opaque or opacified, of polygonal shape or at least partially curved, the electroactive system being as defined in claim 1,
said device being configured to form:
a sunroof for a motor vehicle, that can be activated autonomously, or a side window or a rear window for a motor vehicle or a rear-view mirror;
a windshield or a portion of a windshield of a motor vehicle, of an aircraft or of a ship, a vehicle sunroof;
an aircraft cabin window;
a glazing unit for cranes, construction site vehicles or tractors;
a display panel for displaying graphical and/or alphanumeric information;
an interior or exterior glazing unit for buildings;
a skylight;
a display cabinet or store counter;
a glazing unit for protecting painting objects;
an anti-glare computer screen;
glass furniture; and
a wall for separating two rooms inside a building.

15. A process for manufacturing the electrically controllable device as defined in claim 14, wherein the various layers that compose it are assembled by calendering or laminating optionally with heating, and, when the electrically controllable device is intended to constitute a glazing unit, the various layers composing said system are assembled as a single or multiple glazing unit.

16. A single or multiple glazing unit, comprising an electrically controllable device as defined in claim 14.

17. The electrically controllable device having variable optical/energy properties according to claim 14, wherein at least one of the substrates further comprises another functionality such as a solar control, antireflection or self-cleaning functionality.
